(19) United States
(12) Patent Application Publication
(10) Pub. No.: US 2026/0264059 A1
(43) Pub. Date: Sep. 10, 2026

(54) AMMONIA DECOMPOSITION CATALYST, HONEYCOMB STRUCTURE, AND INTERNAL COMBUSTION ENGINE

(71) Applicant: Murata Manufacturing Co, Ltd., Nagaokakyo-shi (JP)

(72) Inventors: Soichiro TSUJIMOTO, Nagaokakyo-shi (JP); Yousuke SASAKI, Nagaokakyo-shi (JP)

(21) Appl. No.: 19/657,676

(22) Filed: Apr. 24, 2026

Related U.S. Application Data
(63) Continuation of application No. PCT/JP2024/038497, filed on Oct. 29, 2024.

(30) Foreign Application Priority Data
Oct. 31, 2023 (JP) 2023-186621

(51) Int. Cl. B01J 23/58; B01J 23/00; B01J 35/57; B01J 35/70; B01J 37/00; B01J 37/02; B01J 37/04; B01J 37/08; C01B 3/047; F01N 3/28

(52) U.S. Cl. CPC B01J 23/58; B01J 23/002; B01J 35/57; B01J 35/733; B01J 37/0036; B01J 37/0215; B01J 37/04; B01J 37/08; C01B 3/047; F01N 3/2803; B01J 2523/25; B01J 2523/48; B01J 2523/821; F01N 2370/02; F01N 2510/068

(57) ABSTRACT

An ammonia decomposition catalyst including a composite oxide forming a perovskite structure with at least barium, zirconium, and ruthenium. Also included is a honeycomb structure including the ammonia decomposition catalyst and an internal combustion engine including the ammonia decomposition catalyst. The ammonia decomposition catalyst exhibits excellent initial activity even at low temperatures and excellent heat resistance in terms of ammonia decomposition activity.

### CROSS REFERENCE TO RELATED APPLICATIONS

This application is a continuation of International Application No. PCT/JP2024/038497, filed Oct. 29, 2024, which claims priority to Japanese Patent Application No. 2023-186621, filed Oct. 31, 2023, the entire contents of each of which are hereby incorporated by reference in their entirety.

### TECHNICAL FIELD

The present disclosure relates to an ammonia decomposition catalyst, and further relates to a honeycomb structure and an internal combustion engine.

### BACKGROUND

Ammonia decomposition catalysts tend to exhibit higher ammonia decomposition activity as the basicity of the catalysts increases. Known compositions of ammonia decomposition catalysts contain an alkali metal or alkaline earth metal element to increase basicity. Japanese Unexamined Patent Application Publication No. 2010-110697 discloses an ammonia decomposition catalyst composed of a compound having a perovskite structure represented by the general formula Ba(Ce₁₋ₓRuₓ)O₃, where x is 0.05, 0.25, or 0.5.

Japanese Unexamined Patent Application Publication No. 2024-9392 discloses an ammonia decomposition system using ruthenium (Ru)-supported barium zirconate [5 wt. % Ru/SrₓBa₍₁₋ₓ₎ZrO₃ (x=0.125)] as an ammonia decomposition catalyst. “Ruthenium catalyst supported on Ba modified ZrO₂ for ammonia decomposition to COₓ-free hydrogen”, International Journal of Hydrogen Energy, 2019, Vol. 44, pp. 7300-7307 discloses a catalyst in which metallic Ru nanoparticles are supported on a carrier composed of BaZrO₃ and ZrO₂.

The ammonia decomposition catalyst disclosed in Japanese Unexamined Patent Application Publication No. 2010-110697 is not sufficient in initial activity at 600° C. in terms of ammonia decomposition activity. This is believed to be because the ammonia decomposition catalyst, in which Ru is dissolved in the compound having a perovskite structure represented by the general formula BaCeO₃, has a low SSA (Specific Surface Area) and cannot exhibit sufficient activity.

On the other hand, in the catalysts disclosed in Japanese Unexamined Patent Application Publication No. 2024-9392 and “Ruthenium catalyst supported on Ba modified ZrO₂ for ammonia decomposition to COₓ-free hydrogen”, International Journal of Hydrogen Energy, 2019, Vol. 44, pp. 7300-7307, ruthenium is not dissolved in the crystal structure but is merely supported on the carrier. Thus, fixation between ruthenium and the carrier is insufficient, and ruthenium is likely to aggregate when the catalyst is used at high temperatures. This is likely to cause a decrease in the dispersibility of ruthenium as an active metal, making it difficult for the catalyst to sufficiently exhibit its performance.

### SUMMARY OF THE INVENTION

In view of the foregoing, the present disclosure provides an ammonia decomposition catalyst that exhibits excellent initial activity in terms of ammonia decomposition activity even at low temperatures and exhibits stable and excellent heat resistance even at high temperatures such as 1000° C. or higher, and provides a honeycomb structure and an internal combustion engine, each including the ammonia decomposition catalyst. The present disclosure further provides an ammonia decomposition catalyst that achieves an ammonia conversion rate of 50% or more at a temperature of 450° C. even after the catalyst has undergone heat treatment at 1200° C. for 10 hours.

In an exemplary aspect, an ammonia decomposition catalyst according to the present disclosure includes a composite oxide forming a perovskite structure with at least barium, zirconium, and ruthenium.

In an exemplary aspect, an ammonia decomposition catalyst is provided that exhibits excellent initial activity in terms of ammonia decomposition activity even at low temperatures and exhibits stable and excellent heat resistance even at high temperatures such as 1000° C. or higher, and to provide a honeycomb structure and an internal combustion engine, each including the ammonia decomposition catalyst. The present disclosure may thus provide an ammonia decomposition catalyst that achieves an ammonia conversion rate of 50% or more at a temperature of 450° C. even after the catalyst has undergone heat treatment at 1200° C. for 10 hours.

### BRIEF DESCRIPTION OF DRAWINGS

FIG. 1 is a schematic diagram illustrating an internal combustion engine according to aspects of the present disclosure.

FIG. 2 is a schematic diagram illustrating an ammonia decomposition apparatus as used in the Examples.

FIG. 3 is a graph plotting “M_{Ru}/M_{Zr}” against “M_{Ba}/(M_{Zr}+M_{Ru})” for ammonia decomposition catalysts of the Examples.

### DETAILED DESCRIPTION

In an exemplary aspect, the ammonia decomposition catalyst of the present disclosure may include a catalyst for decomposing ammonia (NH₃) and may include a composite oxide (hereinafter also referred to as a first composite oxide) forming a perovskite structure with at least barium (Ba), zirconium (Zr), and ruthenium (Ru). The ammonia decomposition catalyst may include a composite oxide forming a perovskite structure composed of barium, zirconium, and ruthenium. The presence of the first composite oxide in the ammonia decomposition catalyst can be confirmed by X-ray diffraction (XRD) analysis, elemental mapping by EDX (energy dispersive X-ray spectroscopy) using a TEM (transmission electron microscope), or X-ray absorption fine structure (XAFS) measurement.

At least in part due to the inclusion of the first composite oxide, the ammonia decomposition catalyst may exhibit excellent initial activity even at low temperatures and excellent heat resistance in terms of ammonia decomposition activity. It should be understood that a low temperature may be, but is not limited to, a temperature of between about 350° C. and 600° C. In an exemplary aspect, owing to the inclusion of the first composite oxide, the ammonia decomposition catalyst may achieve an ammonia conversion rate of 80% or more at a temperature of 400° C. even after the catalyst has undergone heat treatment at a temperature of 1000° C. for 2 hours. Ammonia conversion rate (%) as described herein is determined according to the evaluation method described in the Examples below.

In composite oxides having a perovskite structure represented by the general formula ABO₃, a perovskite-type composite oxide containing Ba at the A site may have high, and thus excellent, basicity. Such an oxide may thus exhibit excellent characteristics as an ammonia decomposition catalyst. Further, it has been found that in some aspects, a perovskite-type composite oxide containing Zr at the B site tends to have higher heat resistance and higher SSA compared to a perovskite-type composite oxide containing Ce at the B site, and therefore is advantageous as a catalyst base material. In addition, Ru⁴⁺ may easily dissolve at the Zr⁴⁺ site, ensuring high dispersibility and heat resistance of Ru in the perovskite structure. That may achieve both excellent initial activity even at low temperatures and excellent heat resistance in terms of ammonia decomposition activity. It has thus been surprisingly discovered that a composite oxide having a perovskite structure represented by the general formula BaZrO₃ exhibits high activity for ammonia decomposition, which was unexpected at least in part considering that there is no correlation between oxidation activity and ammonia decomposition activity.

In an exemplary aspect, the first composite oxide may have a solid-solution crystal structure in which part of Zr constituting the crystal lattice is substituted with Ru in the perovskite structure represented by the general formula BaZrO₃ (hereinafter also referred to as a Ru-dissolved BaZro₃ structure). It may thus be possible to achieve both excellent initial activity even at low temperatures and excellent heat resistance in terms of ammonia decomposition activity. In a composite oxide having a perovskite structure represented by the general formula BaZro₃, when at least one of Ru and an oxide thereof is merely supported without forming a solid-solution crystal structure in which part of Zr is substituted with Ru, Ru may not sufficiently fixed, and catalytic activity, particularly heat resistance, is less likely to be exhibited in terms of ammonia decomposition activity. The fact that the crystal structure of the first composite oxide is a solid-solution crystal structure in which Ru is dispersed and incorporated in the crystal lattice of a perovskite structure represented by the general formula BaZrO₃ can be confirmed by XRD analysis, TEM-EDX analysis, or XAFS analysis.

In an exemplary aspect wherein the molar ratio of Ba to Zr in the ammonia decomposition catalyst (hereinafter also referred to as a Ba/Zr ratio) is represented by M1, M1 may satisfy the following formula (1):

$$0.2 \leq M 1 \leq 5. \qquad ( 1 )$$

In an exemplary aspect, when the ammonia decomposition catalyst further includes a compound containing Ba (hereinafter also referred to as a barium compound) in addition to the first composite oxide (for example as a promoter or a residual raw material), Ba in the Ba/Zr ratio may be calculated as the total amount of Ba contained in the first composite oxide and the barium compound.

In an exemplary aspect, the ammonia decomposition catalyst may contain, as a ruthenium component, only Ru in a dissolved state in the crystal lattice of the first composite oxide. In an exemplary aspect, in addition to Ru existing in a dissolved state in the crystal lattice of the first composite oxide, the ammonia decomposition catalyst may also contain at least one of Ru existing as a metal, without being dissolved, in the crystal lattice of the first composite oxide and an oxide of Ru (for example, RuO₂). In an exemplary aspect, the Ru existing as a metal, without being dissolved, in the crystal lattice of the first composite oxide and the oxide of Ru may be supported on the first composite oxide.

When the ruthenium component in the ammonia decomposition catalyst is expressed as metallic ruthenium, the content of metallic ruthenium may be, for example, not less than 0.4% by mass and not more than 20% by mass based on the mass of the first composite oxide (or the composite oxide having a Ru-dissolved BaZrO₃ structure). In an exemplary aspect, when at least one of Ru existing as a metal, without being dissolved, in the crystal lattice of the first composite oxide and an oxide of Ru is supported on the first composite oxide as described herein, the mass of the first composite oxide may include the mass of the Ru and the oxide of Ru supported on the first composite oxide.

The molar ratio M2 of Ru existing in a dissolved state in the crystal lattice of the first composite oxide to the metallic ruthenium may be, for example, more than 0 and not more than 1.0. In an exemplary aspect, the molar ratio M2 may be not less than 0.01 and not more than 1.0, optionally not less than 0.1 and not more than 1.0, optionally not less than 0.3 and not more than 1.0, and optionally not less than 0.5 and not more than 1.0.

When the number of moles of Ru contained in the first composite oxide is represented by M_{Ru}, and the numbers of moles of Zr and Ba contained in the ammonia decomposition catalyst are represented by M_{Zr} and M_{Ba}, respectively, the ammonia decomposition catalyst may satisfy the following formulas (a) to (c):

$$0.031 \leq {M}_{R u} / {M}_{Z r} \leq 0 \text{.205} \qquad ( a )$$

$$0.5 \leq {M}_{B a} / ( {M}_{Z r} + {M}_{R u} ) \leq 1.1 \qquad ( b )$$

$$0 < [ 0. 242 \times {M}_{B a} / ( {M}_{Z r} + {M}_{R u} ) ] + {M}_{R u} / {M}_{Z r} - 0.274 \qquad ( c )$$

M_{Ru} is the number of moles of Ru constituting the perovskite structure of the first composite oxide, and does not include, for example, Ru and a Ru oxide supported on the ammonia decomposition catalyst. M_{Zr} and M_{Ba} represent the total numbers of moles of Zr and Ba, respectively, contained in the first composite oxide and in other forms.

In an exemplary aspect, the ammonia decomposition catalyst satisfying formulas (a) to (c) may achieve an ammonia conversion rate of 50% or more at a temperature of 450° C. even after it has undergone heat treatment at 1200° C. for 10 hours. When M_{Ru}/M_{Zr} is less than 0.031 in formula (a), the ammonia conversion rate at 450° C. may not be 50% or more. When M_{Ru}/M_{Zr} exceeds 0.205 in formula (a), the first composite oxide may not form Ba₄ZrRu₃O₁₂, and the first composite oxide having a Ru-dissolved BaZro₃ structure may not be obtained. When M_{Ba}/(M_{Zr}+M_{Ru}) is less than 0.500 in formula (a), heat resistance may decrease. When M_{Ba}/(M_{Zr}+M_{Ru}) exceeds 1.100 in formula (b), the first composite oxide may form Ba₅Ru₂O₁₀, and the first composite oxide having a Ru-dissolved BaZrO₃ structure may not be obtained. When the ammonia decomposition catalyst satisfies formula (c), it is more likely to achieve an ammonia conversion rate (%) of 50% or more at 450° C.

In an exemplary aspect, the lower limit of formula (c) may be 0.0007.

In an exemplary aspect, the ammonia decomposition catalyst may satisfy the following formulas (a′) to (c′):

$$0.053 \leq {M}_{R u} / {M}_{Z r} \leq 0 \text{.205} \qquad ( {a}^{′} )$$

$$0.7 \leq {M}_{B a} / ( {M}_{Z r} + {M}_{R u} ) \leq 1.08 \qquad ( {b}^{′} )$$

$$0 < [ 0.319 \times {M}_{B a} / ( {M}_{Z r} + {M}_{R u} ) ] + {M}_{R u} / {M}_{Z r} - 0.381 \qquad ( {c}^{′} )$$

In an exemplary aspect when the ammonia decomposition catalyst satisfies formulas (a′) to (c′), it may achieve an ammonia conversion rate of 70% or more at a temperature of 450° C. even after it has undergone heat treatment at 1200° C. for 10 hours. When M_{Ru}/M_{Zr} is less than 0.053 in formula (a′), the ammonia conversion rate at 450° C. may not be 70% or more. When M_{Ru}/M_{Zr} exceeds 0.205 in formula (a′), the first composite oxide may not form Ba₄ZrRu₃O₁₂, and the first composite oxide having a Ru-dissolved BaZro₃ structure may not be obtained. When M_{Ba}/(M_{Zr}+M_{Ru}) is less than 0.700 in formula (b′), heat resistance may decrease. When M_{Ba}/(M_{Zr}+M_{Ru}) exceeds 1.080 in formula (b′), the ammonia conversion rate at 450° C. may not be 70% or more. When the ammonia decomposition catalyst satisfies formula (c′), it may achieve an ammonia conversion rate (%) of 70% or more at 450° C.

In an exemplary aspect, the lower limit of formula (c′) may be 0.0002.

In an exemplary aspect, the ammonia decomposition catalyst may satisfy the following formulas (a″) to (c″):

$$0.075 \leq {M}_{R u} / {M}_{Z r} \leq 0 \text{.205} \qquad ( {a}^{″} )$$

$$0.95 \leq {M}_{B a} / ( {M}_{Z r} + {M}_{R u} ) \leq 1.05 \qquad ( {b}^{″} )$$

$$0 < [ 1.009 \times {M}_{B a} / ( {M}_{Z r} + {M}_{R u} ) ] + {M}_{R u} / {M}_{Z r} - 1.114 . \qquad ( {c}^{″} )$$

In an exemplary aspect, when the ammonia decomposition catalyst satisfies formulas (a″) to (c″), it may achieve an ammonia conversion rate of 90% or more at a temperature of 450° C. even after it has undergone heat treatment at 1200° C. for 10 hours. When M_{Ru}/M_{Zr} is less than 0.075 in formula (a″), the ammonia conversion rate at 450° C. may not be 90% or more. When M_{Ru}/M_{Zr} exceeds 0.205 in formula (a″), the first composite oxide may not form Ba₄ZrRu₃O₁₂, and the first composite oxide having a Ru-dissolved BaZro₃ structure may not be obtained. When M_{Ba}/(M_{Zr}+M_{Ru}) is less than 0.950 in formula (b″), heat resistance may decrease. When M_{Ba}/(M_{Zr}+M_{Ru}) exceeds 1.050 in formula (b″), the ammonia conversion rate at 450° C. may not be 90% or more. When the ammonia decomposition catalyst satisfies formula (c″), it may achieve an ammonia conversion rate (%) of 90% or more at 450° C.

In an exemplary aspect, the lower limit of formula (c″) may be 0.0005.

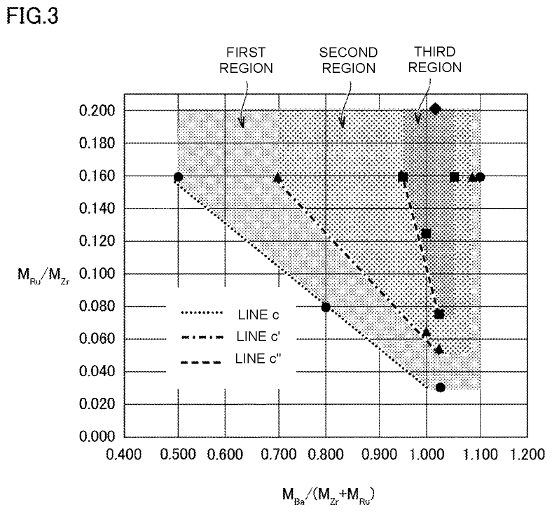

FIG. 3 is a graph in which “M_{Ru}/M_{Zr}” is plotted against “M_{Ba}/(M_{Zr}+M_{Ru})” for an example ammonia decomposition catalyst, with “M_{Ru}/M_{Zr}” on the Y-axis and “M_{Ba}/(M_{Zr}+M_{Ru})” on the X-axis. In FIG. 3, the region satisfying formulas (a) to (c) is shown as a first region. In FIG. 3, the region satisfying formulas (a′) to (c′) is shown as a second region. In FIG. 3, the ammonia decomposition catalyst satisfying formulas (a″) to (c″) is shown as being within a third region. In FIG. 3, formulas (c), (c′), and (c″) correspond to line c defining the first region, line c′ defining the second region, and line c″ defining the third region, respectively.

M_{Ru}, M_{Zr}, and M_{Ba} may be determined from the raw material ratio (molar ratio) used for producing the ammonia decomposition catalyst. Further, M_{Ru}, M_{Zr}, and M_{Ba} may be determined by the method described below. The atomic ratio of Ba, Zr, and Ru contained in the ammonia decomposition catalyst or in the first composite oxide may be determined by X-ray fluorescence (XRF) analysis, inductively coupled plasma (ICP) emission spectrometry, and/or the like.

Whether Ru is supported on the ammonia decomposition catalyst or is dissolved in the perovskite structure of the first composite oxide may be determined by using a combination of X-ray diffraction (XRD) measurement, a scanning electron microscope (SEM), and/or a transmission electron microscope (TEM).

In an exemplary aspect, the ratio of Ru supported on the surface of the ammonia decomposition catalyst and Ru dissolved in the perovskite structure of the first composite oxide can be calculated using X-ray absorption fine structure (XAFS) measurement, and/or hard X-ray photoelectron spectroscopy (HAXPES).

In an exemplary aspect, when the ammonia decomposition catalyst is subjected to a reduction treatment under appropriate conditions, Ru supported on the catalyst may be reduced to a zero-valent state, i.e., a metallic state, while Ru dissolved in the perovskite structure (e.g., BaZrO₃) of the first composite oxide may maintain its cationic state. By analyzing the catalyst after the reduction treatment by XAFS or HAXPES, the ratio between Ru in the metallic state and Ru in the cationic state may be determined. Further, in examples when it is assumed that Ru in the metallic state is the supported Ru, and Ru in the cationic state is Ru dissolved in the perovskite structure (e.g., BaZro₃) of the first composite oxide, the proportion of the amount of dissolved Ru in the total amount of Ru contained in the ammonia decomposition catalyst may be calculated.

In XAFS measurement, a transmission method or a fluorescence yield method with an analysis depth of several micrometers may be used. In HAXPES, since the Ru3d peak in the Ru spectrum overlaps with the C1s peak, the Ru3p3 peak is used to calculate the concentration of Ru. The coefficient for converting the Ru3p3 peak intensity into the Ru concentration may corrected using a standard sample having a known Ru concentration.

Since HAXPES is susceptible to surface contamination of a sample, care is required when an atom other than Ba, Zr, Ru, and O is detected at a high concentration. In an exemplary aspect when HAXPES has a maximum analysis depth of about 50 nm, analysis by XAFS may be used when the particle size of the ammonia decomposition catalyst exceeds 50 nm.

In an exemplary aspect, the ammonia decomposition catalyst may further include one or more of magnesium, an alkali metal, an alkaline earth metal, yttrium (Y), and a rare earth element as a promoter to increase basicity. In an exemplary aspect, the promoter may be present in the form of at least one of an oxide, a carbonate, a hydroxide, and a metal. Examples of the alkali metal include lithium (Li), sodium (Na), potassium (K), rubidium (Rb), Cs (cesium), and combinations thereof. Examples of the alkaline earth metal include calcium (Ca), strontium (Sr), barium (Ba), and combinations thereof. Examples of the rare earth element include scandium (Sc), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), and combinations thereof. In an exemplary aspect when the ammonia decomposition catalyst contains such a promoter, the content of the promoter may be, for example, less than 50 parts by mass, optionally 30 parts by mass or less, and may be, for example, more than 0 parts by mass, based on 100 parts by mass of the first composite oxide.

In an exemplary aspect, the ammonia decomposition catalyst may further include a binder and/or an organic solvent, such as to facilitate processing of the catalyst into a granular or honeycomb shape and/or to facilitate coating of the catalyst onto a substrate.

In an exemplary aspect, the content of the first composite oxide in the ammonia decomposition catalyst may be, for example, 100% by mass or less, 95% by mass or less, or 90% by mass or less, and/or may be 50% by mass or more, based on the mass of the ammonia decomposition catalyst. In an exemplary aspect, when a substrate is coated with the ammonia decomposition catalyst as in the case of the honeycomb structure, the mass of the ammonia decomposition catalyst may correspond with the mass of the catalyst coated on the substrate and may not include the mass of the substrate (e.g., a honeycomb-shaped substrate).

In an exemplary aspect, the ammonia decomposition catalyst may be produced by first wet-mixing BaCO₃, ZrO₂, and RuO₂ with cobblestones and water to obtain a mixture. Next, the resulting mixture may be dried, such as at a temperature of 100 to 120° C. with stirring on a hot plate, and then pulverized and sized into particles, such as particles having a particle diameter on the order of several hundred micrometers to several millimeters. Thereafter, the resulting particulate sample may be calcined in air, for example, at a temperature of 900 to 1200° C., optionally of 900 to 1100° C. for 2 to 10 hours.

In an exemplary aspect, the ammonia decomposition catalyst may have an excellent initial activity even at low temperatures and may thus exhibit high ammonia decomposition activity at a temperature of 400° C. Furthermore, the ammonia decomposition catalyst may exhibit excellent heat resistance and catalytic activity over a long period of time even at relatively high temperatures. The temperature at which the ammonia decomposition catalyst can exhibit catalytic activity may be, in some non-limiting examples, 350° C. or higher, 400° C. or higher, and/or 500° C. or higher, and/or may be, for example, 900° C. or lower, 800° C. or lower, and/or 700° C. or lower. In an exemplary aspect, the ammonia decomposition catalyst may exhibit an ammonia decomposition activity of 50% or more, optionally 70% or more, and optionally 90% or more at a temperature of 450° C. after it has undergone heat treatment at 1200° C. for 10 hours.

In an exemplary aspect, the ammonia decomposition catalyst may exhibit excellent initial activity even at low temperatures and excellent heat resistance in terms of ammonia decomposition activity, and may thus be used in internal combustion engines using ammonia and engines that decompose ammonia to produce hydrogen.

In an exemplary aspect, the ammonia decomposition catalyst may be in the form of a pellet catalyst having a granular shape, including but not limited to a granular shape with a diameter of several millimeters to several centimeters. In an exemplary aspect, the ammonia decomposition catalyst may be in the form of a honeycomb catalyst having a honeycomb shape. In an exemplary aspect, the ammonia decomposition catalyst can also be used in the form of a honeycomb structure as described below.

In an exemplary aspect, the ammonia decomposition catalyst may decompose ammonia when in contact with ammonia and heated. In an exemplary aspect, the ammonia may include ammonia gas (i.e., gaseous ammonia). In an exemplary aspect, the heating temperature (also referred to as a first heating temperature) for decomposing ammonia by heating the ammonia decomposition catalyst may be, for example, not less than 350° C. and/or not more than 900° C. In some non-limiting examples, the heating temperature may be not less than 350° C. and/or not more than 700° C., optionally not less than 350° C. and/or not more than 600° C., and optionally not less than 350° C. and/or not more than 550° C.

An example method for heating the ammonia decomposition catalyst in contact with ammonia may include loading the catalyst into a tube, introducing ammonia into the tube, and heating the tube from the outside at least a site where the ammonia decomposition catalyst is in contact with ammonia in the tube. In an exemplary aspect, the ammonia decomposition catalyst to be loaded into the tube may be a pellet catalyst, a honeycomb catalyst, a honeycomb structure as described below, or a combination thereof. Additionally or alternatively, an aggregate of the ammonia decomposition catalyst may be used.

In an exemplary aspect, the catalytic activity may be increased by heating the ammonia decomposition catalyst before ammonia is brought into contact with the ammonia decomposition catalyst, such as to a temperature equal to or higher than the first heating temperature in a reducing atmosphere and/or under a flow of a reducing gas. The reducing atmosphere may be obtained, for example, by diluting hydrogen, nitrogen, ammonia, or a combination thereof. The heating temperature (hereinafter also referred to as a second heating temperature) for heating the ammonia decomposition catalyst to a temperature equal to or higher than the first heating temperature before bringing ammonia into contact with the catalyst may be, for example, not less than 300° C. and/or not more than 900° C., and/or may be not less than 400° C. and/or not more than 800° C., optionally not less than 600° C. and/or not more than 800° C. The time for heating the ammonia decomposition catalyst at the second heating temperature before bringing ammonia into contact with the catalyst may be, for example, 1 to 10 hours.

Aspects of the present disclosure are also directed to a honeycomb structure including a honeycomb-shaped substrate coated with the ammonia decomposition catalyst described herein. In an exemplary aspect, a honeycomb shape may be configured to enable a reduction in pressure loss upon passage of ammonia gas. By increasing the cell density of the honeycomb, the effective surface area may increase, thereby enabling an increase in the ammonia decomposition rate.

Other aspects of the present disclosure are directed to an internal combustion engine that generates driving force accompanied by the combustion of at least hydrogen. In an exemplary aspect, the internal combustion engine may include an engine main body including a combustion chamber; an ammonia supply unit that supplies ammonia; and a hydrogen generation unit disposed between the ammonia supply unit and the combustion chamber, wherein the hydrogen generation unit may include the ammonia decomposition catalyst as described herein.

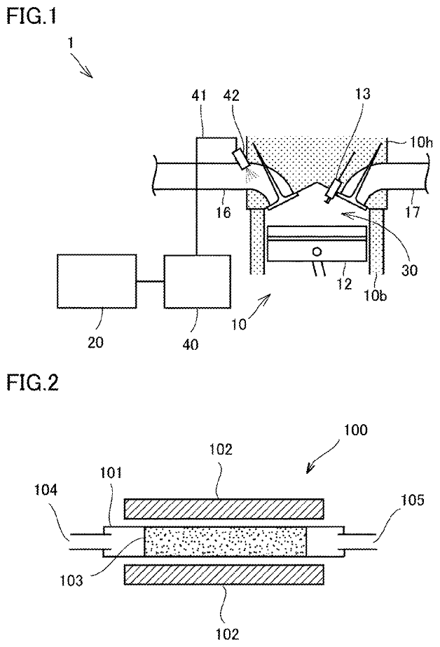

FIG. 1 is a schematic view of an example internal combustion engine according to the present disclosure. The internal combustion engine 1 shown in FIG. 1 may be mounted, for example, on a vehicle, and may generate driving force for driving the vehicle. The internal combustion engine 1 may include an engine main body 10, an ammonia supply unit 20, a combustion chamber 30, and a hydrogen generation unit 40.

In an exemplary aspect, the engine main body 10 may generate driving force through the combustion of at least hydrogen. In an exemplary aspect, ammonia may be combusted in addition to hydrogen. In this example, the engine main body 10 may be of a spark-ignition type and includes a cylinder block 10b and a cylinder head 10h. A piston 12 may be disposed inside the cylinder block 10b, and the combustion chamber 30 may be formed by a crown surface of the piston 12 and the cylinder head 10h. In an exemplary aspect, the combustion chamber 30 may be formed for each cylinder.

In an exemplary aspect, an intake pipe 16 forming an intake passage to the combustion chamber 30 via the interior of the cylinder block 10b, and an exhaust pipe 17 forming an exhaust passage from the combustion chamber 30, may be connected to the combustion chamber 30.

In an exemplary aspect, an ignition plug 13 as an ignition device may be fixed in the combustion chamber 30. The ammonia supply unit 20 may be configured to supply ammonia to the hydrogen generation unit 40. The ammonia supply unit 20 may be configured to be internally pressurized and store ammonia. In an exemplary aspect, the stored ammonia may include liquefied ammonia. The hydrogen generation unit 40 may contain the above-described ammonia decomposition catalyst (not shown). The hydrogen generation unit 40 may be configured to heat ammonia to a predetermined temperature to decompose it and thereby generate hydrogen (H₂) according to the following formula (i):

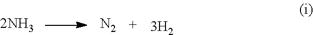

In an exemplary aspect, the ammonia supplied to the hydrogen generation unit 40 may include ammonia gas, and/or the hydrogen generated by the hydrogen generation unit 40 may include hydrogen gas.

In an exemplary aspect, the decomposition reaction of ammonia may be an endothermic reaction. Therefore, the hydrogen generation unit 40 may obtain the heat necessary for the ammonia decomposition reaction from the heat of an ammonia oxidation reaction due to the oxidation function of the ammonia decomposition catalyst, contained in the unit 40, or from a heating unit that heats ammonia. The ammonia oxidation reaction may be, for example, the reaction shown in the following formula (ii):

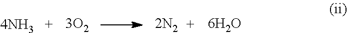

In an exemplary aspect, hydrogen generated by the hydrogen generation unit 40 may be supplied to a first supply unit 42 via a first supply pipe 41. The first supply unit 42 may be disposed on the intake pipe 16 and provided on the downstream side of the intake passage. It should be understood that the present disclosure is not limited to supplying hydrogen from the first supply unit 42 to the combustion chamber 30, and may include ammonia that has not been used for the reaction in the hydrogen generation unit 40.

In an exemplary aspect, part of ammonia may be directly supplied into the combustion chamber, without being supplied to the hydrogen generation unit 40, from a second supply pipe provided between the ammonia supply unit 20 and the hydrogen generation unit 40. In an exemplary aspect, a hydrocarbon may also be supplied into the combustion chamber from a third supply pipe. The hydrocarbon to be supplied may be a hydrocarbon gas. The hydrocarbon may be, for example, methane, gasoline, or light oil. In another variation embodiment, part of ammonia may be directly supplied into the exhaust pipe 17, without being supplied to the hydrogen generation unit 40, from a fourth supply pipe provided between the ammonia supply unit 20 and the hydrogen generation unit 40. In an exemplary aspect, ammonia supplied to the combustion chamber 30 may be supplied to the exhaust pipe 17 together with exhaust gas.

The present disclosure will now be described further by way of examples.

### EXAMPLES

### Example 1

BaCO₃, ZrO₂, and RuO₂ were weighed at a molar ratio of Ba:Zr:Ru=1.00:1.00:0.17. The materials were wet-mixed with cobblestones and water to obtain a mixture. The resulting mixture was dried at a temperature of 110° C. with stirring on a hot plate, and then pulverized and sized to obtain a catalyst precursor powder. Thereafter, the catalyst precursor powder was calcined in air at a temperature of 1000° C. for 2 hours to produce a composite oxide having a perovskite structure of Ru-dissolved BaZrO₃. The ammonia decomposition catalyst of Example 1 was thus produced. When the ruthenium component in the composite oxide was expressed as metallic ruthenium, the content of metallic ruthenium was 5.9% by mass based on the mass of the composite oxide.

### [Confirmation of Crystal Phase]

The ammonia decomposition catalysts of the example and a comparative example were each pulverized in a mortar, and the resulting powder was subjected to powder XRD measurement (X-ray source: Cu-Kα1) to determine the crystal phase. The results are shown in Table 1.

Based on a TEM (transmission electron microscope) image of the ammonia decomposition catalyst of Example 1 and an elemental mapping image by EDX (energy dispersive X-ray spectroscopy) in the same field of view, it was confirmed that the catalyst has a solid-solution crystal structure in which Ru is dispersed and incorporated in the crystal lattice of the perovskite structure represented by the general formula BaZro₃.

### Comparative Example 1

Commercially available 5 mass % Ru/Al₂O₃ (ruthenium supported on alumina) was prepared.

### [Evaluation of Ammonia Decomposition Activity]

The ammonia decomposition activity of the catalysts of Example 1 and Comparative Example 1 was evaluated. 0.5 g of catalyst 103 was loaded into a reaction tube 101 of the ammonia decomposition apparatus 100 shown in FIG. 2. The catalyst 103 was heated by a heater 102 at a temperature of 600° C. for 2 hours while allowing ammonia to flow through the catalyst at 42 ml/min. Subsequently, after the heater temperature was set to 400° C., the catalyst 103 was heated at 400° C. by the heater 102 while introducing 100% NH₃ at 42 ml/min from an ammonia inlet 104. During the reaction evaluation, the gas exiting a decomposed gas outlet 105 was introduced into a gas chromatograph to measure the ammonia conversion rate (%). The ammonia conversion rate [NH₃ conv. (%)] was calculated according to the following formula:

$${NH}_{3} conv . ( \% ) = 1 - ( [ {NH}_{3} ] t / [ {NH}_{3} ] r . t . )$$

(where [NH₃]t represents the ammonia concentration (%) at temperature t, and
[NH₃]r. t. represents the ammonia concentration (%) at the start of measurement (room temperature).)

A higher ammonia conversion rate indicates superior ammonia decomposition activity (initial activity). The space velocity was approximately 5000 ml/(gh)⁻¹ in both Example 1 and Comparative Example 1.

TABLE 1

| | | Ammonia |
|---|---|---|
| | | conversion |
| | | rate |
| | Crystal phase | (%) |
| Example 1 | BaZrO₃ | 80% or more |
| Comp. Example 1 | Ru, Al₂O₃ | 50% or less |

In Example 1, the ammonia conversion rate at a temperature of 400° C. (t=400° C.) was 80% or more, whereas in Comparative Example 1, the ammonia conversion rate at a temperature of 400° C. (t=400° C.) was 50% or less.

The ammonia decomposition catalyst achieved an ammonia conversion rate of 80% or more at a temperature of 400° C. even after the catalyst had undergone the heat treatment for calcination at 1000° C. This indicates that the ammonia decomposition catalyst of the present disclosure exhibited excellent initial activity and thermal stability in terms of ammonia decomposition activity.

### Examples 2 to 14

BaCO₃, ZrO₂, and RuO₂ were weighed at a Ba: Zr: Ru molar ratio shown in Table 2. The materials were wet-mixed with cobblestones and water to obtain a mixture. The resulting mixture was dried at a temperature of 110° C. with stirring on a hot plate, and then pulverized and classified to obtain particles having a size of not less than 315 μm and not more than 800 μm. Thereafter, the particulate sample was calcined in air at a temperature of 1200° C. for 10 hours, and the resulting powder was pulverized and classified to produce a catalyst powder having a size of not less than 510 μm and not more than 700 μm, and mainly containing a Ru-dissolved BaZrO₃ composite oxide having a perovskite structure. The ammonia decomposition catalysts of Examples 2 to 14 were thus produced. The ammonia decomposition catalysts of Examples 2 to 14 were each pulverized in a mortar, and the resulting powder was subjected to powder XRD measurement (X-ray source: Cu-Kα1) to determine the crystal phase. As a result, the crystal phase was found to be mainly composed of BaZrO₃. Further, based on a TEM (transmission electron microscope) image of each of the ammonia decomposition catalysts of Examples 2 to 14 and an elemental mapping image by EDX (energy dispersive X-ray spectroscopy) in the same field of view, the catalysts were confirmed to have a solid-solution crystal structure in which Ru is dispersed and incorporated in the crystal lattice of the perovskite structure represented by the general formula BaZro₃. M_{Ru}/M_{Zr} and M_{Ba}/(M_{Zr}+M_{Ru}) are shown in Table 3.

TABLE 2

| | Ba:Zr:Ru |
|---|---|
| Example 2 | 0.500:0.863:0.137 |
| Example 3 | 0.800:0.925:0.075 |
| Example 4 | 1.030:0.970:0.030 |
| Example 5 | 1.100:0.863:0.137 |
| Example 6 | 0.700:0.863:0.137 |
| Example 7 | 1.000:0.940:0.060 |
| Example 8 | 1.030:0.950:0.050 |
| Example 9 | 1.080:0.863:0.137 |
| Example 10 | 0.950:0.863:0.137 |
| Example 11 | 1.000:0.890:0.110 |
| Example 12 | 1.030:0.930:0.070 |
| Example 13 | 1.050:0.863:0.137 |
| Example 14 | 1.030:0.830:0.170 |

### Comparative Example 2

BaCO₃ and ZrO₂ were weighed at a molar ratio of Ba:Zr=0.1:1.0. The materials were wet-mixed with cobblestones and water to obtain a mixture. The resulting mixture was dried at a temperature of 110° C. with stirring on a hot plate, and then pulverized and sized to obtain a catalyst carrier precursor powder. Thereafter, the catalyst carrier precursor powder was calcined in air at a temperature of 700° C. for 6 hours to produce a catalyst carrier mainly containing Zro₂.

RuO₂ was weighed such that the amount of Ru was 3 wt. % based on the amount of the resulting catalyst carrier, and the materials were wet-mixed with cobblestones, water, and a binder to obtain a mixture. The resulting mixture was dried at a temperature of 110° C. with stirring on a hot plate, and then pulverized and classified to obtain particles having a size of not less than 315 μm and not more than 800 μm. Thereafter, the particulate sample was calcined in air at 500° C. for 3 hours, and the resulting powder was pulverized and classified to produce 3 wt. % Ru-supported Ba—ZrO₂ having a size of not less than 510 μm and not more than 700 μm.

The 3 wt. % Ru-supported Ba—ZrO₂ was pulverized in a mortar, and the resulting powder was subjected to powder XRD measurement (X-ray source: Cu-Kα1). As a result, it was confirmed that the main phase was Zro₂ and the secondary phase was BaZro₃. Further, TEM-EDX of the catalyst confirmed that Ru was supported on ZrO₂ and/or BaZrO₃.

The 3 wt. % Ru-supported Ba—ZrO₂ was calcined at 1200° C. for 10 hours. The ammonia decomposition catalyst of Comparative Example 2 was thus produced.

### Comparative Example 3

BaCO₃, CeO₂, and RuO₂ were weighed at a molar ratio of Ba:Ce:Ru=1:0.95:0.05. The materials were wet-mixed with cobblestones, water, and a binder to obtain a mixture. The resulting mixture was dried at a temperature of 110° C. with stirring on a hot plate, and then pulverized and classified to obtain particles having a size of not less than 315 μm and not more than 800 μm. Thereafter, the particulate sample was calcined in air at a temperature of 1000° C. for 10 hours, and the resulting powder was pulverized and classified to produce a BaCe_{0.95}Ru_{0.05}O₃ composite oxide having a size of not less than 510 μm and not more than 700 μm, and having a Ru-dissolved perovskite structure. The ammonia decomposition catalyst of Comparative Example 3 was thus produced. Powder XRD measurement (X-ray source: Cu-Kα1) confirmed that the main phase of the ammonia decomposition catalyst of Comparative Example 3 was BaCeO₃ having a perovskite structure. TEM-EDX confirmed that Ru was dissolved in BaCeO₃.

### Comparative Example 4

BaCO₃, SrCO₃, and Zro₂ were weighed at a molar ratio of Ba:Sr:Zr=0.875:0.125:1.000. The materials were wet-mixed with cobblestones and water to obtain a mixture. The resulting mixture was dried at a temperature of 110° C. with stirring on a hot plate, and then pulverized and sized to obtain a catalyst carrier precursor powder. Thereafter, the catalyst carrier precursor powder was calcined in air at a temperature of 1000° C. for 2 hours to produce Ba_{0.875}Sr_{0.125}Zr_{1.00}O₃ as a catalyst carrier.

RuO₂ was weighed such that the amount of Ru was 5 wt. % based on the amount of the resulting catalyst carrier, and the materials were wet-mixed with cobblestones, water, and a binder to obtain a mixture. The resulting mixture was dried at a temperature of 110° C. with stirring on a hot plate, and then pulverized and classified to obtain particles having a size of not less than 510 μm and not more than 700 μm. Thereafter, the particulate sample was calcined in air at 600° C. for 2 hours to produce a 5 wt. % Ru-supported Ba_{0.875}Sr_{0.125}Zr_{1.00}O₃ composite oxide.

The 5 wt. % Ru-supported Ba_{0.875}Sr_{0.125}Zr_{1.00}O₃ composite oxide was pulverized in a mortar, and the resulting powder was subjected to powder XRD measurement (X-ray source: Cu-Kα1). As a result, the main phase was confirmed to be BaZrO₃. Further, TEM-EDX of the catalyst confirmed that Ru was supported on the oxide having a perovskite structure.

The 5 wt. % Ru-supported Ba_{0.875}Sr_{0.125}Zr_{1.00}O₃ composite oxide was calcined at 1200° C. for 10 hours. The ammonia decomposition catalyst of Comparative Example 4 was thus produced.

### [Evaluation of Ammonia Decomposition Activity]

The ammonia decomposition activity of the catalysts of Examples 2 to 14 and Comparative Examples 2 to 4 was evaluated. 0.344 g of catalyst 103 was loaded into the reaction tube 101 of the ammonia decomposition apparatus 100 shown in FIG. 2. The catalyst 103 was heated by the heater 102 at a temperature of 600° C. for 2 hours while allowing ammonia to flow through the catalyst at 28.7 ml/min. Subsequently, after the heater temperature was set to 450° C., the catalyst 103 was heated at 450° C. by the heater 102 while introducing 100% NH₃ at 28.7 ml/min from the ammonia inlet 104. During the reaction, the gas exiting the decomposed gas outlet 105 was introduced into a gas chromatograph to measure the ammonia conversion rate (%). The ammonia conversion rate [NH₃ conv. (%)] was calculated according to the above-described formula. The space velocity was approximately 5000 ml/(gh)⁻¹ in all of Examples 2 to 14 and Comparative Examples 2 to 4. The results are shown in Table 3.

TABLE 3

| | | | Ammonia |
|---|---|---|---|
| | | | conversion |
| | | | rate (%) at |
| | | M_{Ba}/ | temperature |
| | M_{Ru}/M_{Zr} | (M_{Zr} + M_{Ru}) | of 450° C. |
| Example 2 | 0.159 | 0.500 | 59.8 |
| Example 3 | 0.081 | 0.800 | 60.1 |
| Example 4 | 0.031 | 1.030 | 52.1 |
| Example 5 | 0.159 | 1.100 | 61.0 |
| Example 6 | 0.159 | 0.700 | 83.1 |
| Example 7 | 0.064 | 1.000 | 70.1 |
| Example 8 | 0.053 | 1.030 | 73.6 |
| Example 9 | 0.159 | 1.080 | 79.8 |
| Example 10 | 0.159 | 0.950 | 90.5 |
| Example 11 | 0.124 | 1.000 | 91.3 |
| Example 12 | 0.075 | 1.030 | 90.2 |
| Example 13 | 0.159 | 1.050 | 97.3 |
| Example 14 | 0.205 | 1.030 | 98.6 |
| Comp. Example 2 | — | — | 17.8 |
| Comp. Example 3 | — | — | 38.4 |
| Comp. Example 4 | — | — | 35.7 |

In Examples 2 to 5, the ammonia conversion rate of each catalyst at a temperature of 450° C. (t=450° C.) was 50% or more even after the catalyst had undergone heat treatment at a temperature of 1200° C. for 10 hours. In Examples 6 to 9, the ammonia conversion rate of each catalyst at a temperature of 450° C. (t=450° C.) was 70% or more even after the catalyst had undergone heat treatment at a temperature of 1200° C. for 10 hours. In Examples 10 to 14, the ammonia conversion rate of each catalyst at a temperature of 450° C. (t=450° C.) was 90% or more even after the catalyst had undergone heat treatment at a temperature of 1200° C. for 10 hours. In contrast, in Comparative Examples 2 and 4, the ammonia conversion rate of each catalyst at a temperature of 450° C. (t=450° C.) was less than 50% after the catalyst had undergone heat treatment at a temperature of 1200° C. for 10 hours. In Comparative Example 2, the ammonia conversion rate of the catalyst at a temperature of 450° C. (t=450° C.) was less than 50% despite the heat treatment of the catalyst having been performed at a temperature of 1000° C. for 10 hours.

FIG. 3 shows a graph plotting M_{Ru}/M_{Zr} against M_{Ba}/(M_{Zr}+M_{Ru}) for Examples 2 to 14. The plots of Examples 2 to 4 have a linear relationship. The slope of a line connecting the plots was determined by the least squares method. Further, an intercept, at which the line having the slope does not exceed any of the plotted points, was calculated. The line having the slope and the intercept is line c. Line c defines the first region.

Similarly, line c′ and line c″ were determined from Examples 6 to 8 and Examples 10 to 12, respectively. Line c′ defines the second region, and line c″ defines the third region. The data obtained indicate that ammonia decomposition catalysts within the first region can achieve an ammonia conversion rate of 50% or more at a temperature of 450° C. (t=450° C.) after they have undergone heat treatment at a temperature of 1200° C. for 10 hours. The data also indicate that ammonia decomposition catalysts within the second region can achieve an ammonia conversion rate of 70% or more at a temperature of 450° C. (t=450° C.) after they have undergone heat treatment at a temperature of 1200° C. for 10 hours. Further, the data indicate that ammonia decomposition catalysts within the third region can achieve an ammonia conversion rate of 90% or more at a temperature of 450° C. (t=450° C.) after they have undergone heat treatment at a temperature of 1200° C. for 10 hours.

### REFERENCE SIGNS LIST

1 internal combustion engine
10 engine main body
10b cylinder block
10h cylinder head
12 piston
13 ignition plug
16 intake pipe
17 exhaust pipe
20 ammonia supply unit
30 combustion chamber
40 hydrogen generation unit
41 first supply pipe
42 first supply unit
100 ammonia decomposition apparatus
101 reaction tube
102 heater
103 catalyst
104 ammonia inlet
105 decomposed gas outlet

1. An ammonia decomposition catalyst comprising a composite oxide forming a perovskite structure, wherein the ammonia decomposition catalyst comprises barium, zirconium, and ruthenium in amounts to satisfy (a), (b), and (c):
$$0.031 \leq {M}_{R u} / {M}_{Z r} \leq 0.205 , \qquad ( a )$$
$$0.5 \leq {M}_{B a} / ( {M}_{Z r} + {M}_{R u} ) \leq 1.1 , and \qquad ( b )$$
$$0 < [ 0. 242 \times {M}_{B a} / ( {M}_{Z r} + {M}_{R u} ) ] + {M}_{R u} / {M}_{Z r} - 0.2 \; 74 , \qquad ( c )$$
wherein M_{Ru} represents a number of moles of ruthenium contained in the composite oxide, M_{Zr} represents a number of moles of zirconium contained in the ammonia decomposition catalyst, and M_{Ba} represents a number of moles of barium contained in the ammonia decomposition catalyst.

2. The ammonia decomposition catalyst according to claim 1, wherein M_{Ru}, M_{Zr}, and M_{Ba} satisfy (a′), (b′), and (c′):
$$0.053 \leq {M}_{R u} / {M}_{Z r} \leq 0.205 , \qquad ( {a}^{′} )$$
$$0.7 \leq {M}_{B a} / ( {M}_{Z r} + {M}_{R u} ) \leq 1.08 , and \qquad ( {b}^{′} )$$
$$0 < [ 0.319 \times {M}_{B a} / ( {M}_{Z r} + {M}_{R u} ) ] + {M}_{R u} / {M}_{Z r} - 0.381 . \qquad ( {c}^{′} )$$

3. The ammonia decomposition catalyst according to claim 1, wherein M_{Ru}, M_{Zr}, and M_{Ba} satisfy (a″), (b″), and (c″):
$$0.075 \leq {M}_{R u} / {M}_{Z r} \leq 0.205 , \qquad ( {a}^{″} )$$
$$0.95 \leq {M}_{B a} / ( {M}_{Z r} + {M}_{R u} ) \leq 1.05 , and \qquad ( {b}^{″} )$$
$$0 < [ 1.009 \times {M}_{B a} / ( {M}_{Z r} + {M}_{R u} ) ] + {M}_{R u} / {M}_{Z r} - 1.114 . \qquad ( {c}^{″} )$$

4. The ammonia decomposition catalyst according to claim 1, further comprising a promoter that includes magnesium, an alkali metal, an alkaline earth metal, yttrium, a rare earth element, or a combination thereof.

5. The ammonia decomposition catalyst according to claim 4, wherein the ammonia decomposition catalyst comprises less than 50 parts by mass of the promoter.

6. The ammonia decomposition catalyst according to claim 1, wherein the ammonia decomposition catalyst has a granular shape.

7. The ammonia decomposition catalyst according to claim 1, wherein the ammonia decomposition catalyst has a honeycomb shape.

8. The ammonia decomposition catalyst according to claim 1, wherein the ammonia decomposition catalyst is provided as a coating on a honeycomb-shaped substrate.

9. The ammonia decomposition catalyst according to claim 1, wherein the composite oxide comprises a solid-solution crystal structure having a crystal lattice represented by formula BaZro₃ in which a portion of Zr constituting the crystal lattice is substituted with Ru.

10. A process for preparing an ammonia decomposition catalyst comprising:
wet-mixing BaCO₃, ZrO₂, and RuO₂ with cobblestones and water to obtain a mixture,
drying and sizing the mixture to form a catalyst precursor powder, and
calcining the catalyst precursor powder to provide an ammonia decomposition catalyst comprising a composite oxide forming a perovskite structure,
wherein the ammonia decomposition catalyst comprises barium, zirconium, and ruthenium in amounts to satisfy (a), (b), and (c):
$$0.031 \leq {M}_{R u} / {M}_{Z r} \leq 0.205 , \qquad ( a )$$
$$0.5 \leq {M}_{B a} / ( {M}_{Z r} + {M}_{R u} ) \leq 1.1 , and \qquad ( b )$$
$$0 < [ 0. 242 \times {M}_{B a} / ( {M}_{Z r} + {M}_{R u} ) ] + {M}_{R u} / {M}_{Z r} - 0.2 \; 74 , \qquad ( c )$$
wherein M_{Ru} represents a number of moles of ruthenium contained in the composite oxide, M_{Zr} represents a number of moles of zirconium contained in the ammonia decomposition catalyst, and M_{Ba} represents a number of moles of barium contained in the ammonia decomposition catalyst.

11. The process according to claim 10, wherein M_{Ru}, M_{Zr}, and M_{Ba} satisfy (a″), (b″), and (c″):
$$0.053 \leq {M}_{R u} / {M}_{Z r} \leq 0.205 , \qquad ( {a}^{′} )$$
$$0.7 \leq {M}_{B a} / ( {M}_{Z r} + {M}_{R u} ) \leq 1.08 , and \qquad ( {b}^{′} )$$
$$0 < [ 0.319 \times {M}_{B a} / ( {M}_{Z r} + {M}_{R u} ) ] + {M}_{R u} / {M}_{Z r} - 0.381 . \qquad ( {c}^{′} )$$

12. The process according to claim 10, wherein the composite oxide comprises a solid-solution crystal structure having a crystal lattice represented by formula BaZrO₃ in which a portion of Zr constituting the crystal lattice is substituted with Ru.

13. An internal combustion engine configured to combust at least hydrogen, the internal combustion engine comprising:
an engine main body including a combustion chamber,
an ammonia supply unit configured to supply ammonia to the combustion chamber, and
a hydrogen generation unit disposed between the ammonia supply unit and the combustion chamber,
wherein the hydrogen generation unit comprises the ammonia decomposition catalyst according to claim 1.

14. The internal combustion engine according to claim 13, wherein M_{Ru}, M_{Zr}, and M_{Ba} Satisfy (a″), (b″), and (c″):
$$0.075 \leq {M}_{R u} / {M}_{Z r} \leq 0.205 , \qquad ( {a}^{″} )$$
$$0.95 \leq {M}_{B a} / ( {M}_{Z r} + {M}_{R u} ) \leq 1.05 , and \qquad ( {b}^{″} )$$
$$0 < [ 1.009 \times {M}_{B a} / ( {M}_{Z r} + {M}_{R u} ) ] + {M}_{R u} / {M}_{Z r} - 1.114 . \qquad ( {c}^{″} )$$

15. The internal combustion engine according to claim 13, wherein the ammonia decomposition catalyst further comprises a promoter.

16. The internal combustion engine according to claim 15, wherein the promoter comprises magnesium, an alkali metal, an alkaline earth metal, yttrium, a rare earth element, or a combination thereof.

17. The internal combustion engine according to claim 13, wherein the ammonia decomposition catalyst has a granular shape.

18. The internal combustion engine according to claim 13, wherein the ammonia decomposition catalyst has a honeycomb shape.

19. The internal combustion engine according to claim 13, wherein the ammonia decomposition catalyst is provided as a coating on a honeycomb-shaped substrate.

20. The internal combustion engine according to claim 13, wherein the composite oxide comprises a solid-solution crystal structure having a crystal lattice represented by formula BaZro₃ in which a portion of Zr constituting the crystal lattice is substituted with Ru.
